(19) United States
(12) Patent Application Publication
(10) Pub. No.: US 2002/0053503 A1
(43) Pub. Date: May 9, 2002

(54) Switch having a depressable member

(76) Inventor: Pai-Shan Wang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,468

(22) Filed: Oct. 30, 2001

(30) Foreign Application Priority Data
Nov. 7, 2000 (TW) 89219320

(51) Int. Cl. H01H 3/42

(52) U.S. Cl. 200/524

(57) ABSTRACT

A switch has a base and a depressable member up-and-down movably received in the base. The base has conductive rods passed through the bottom; each having a first contact facing a respective one of second contacts of a bottom of the depressable member and a lower part sticking out for connection with a socket. A fixing hook has a lower portion held in position on an elongated slot of the base bottom, a leaning portion connected to one end of the lower portion, and an engaging portion connected to the upper end of the leaning portion. The depressable member further bas an engaging surface facing the engaging portion for disengagably engaging the hook engaging portion. The depressable member is normally biased up to a power-off position by a spring positioned on the lower position of the hook. When the depressable member is depressed for the engaging portion to engage a power-on spot of the engaging surface for locking same in a power-on position; the spring will press the lower portion of the hook, causing the leaning portion to lean further forwards so as to cause the engaging portion to sufficiently abut the engaging surface.

### BACKGROUND OF THE INVENTION

The present invention relates to a switch, and more particularly, to a switch having a movable member, which is depressed for the start or stop of the flow of electricity.

Referring to FIGS. 1, and 2, a conventional switch includes a depressable member 15, a fixing hook 13, a propping plate 12, and a base 11. The base 11 has a bottom part 111, an annular wall 112, a holding room 113 defined by the annular wall 112, and a positioning trench 114 formed on an inner side of the wall 112 to communicate with the holding room 113; the holding room 113 has an upper opening. At least two conductive rods 14 are firmly passed through the bottom part 111, each giving an upper portion received in the holding room 113 and a lower portion sticking out from the bottom part 111 for connection to a socket.

The propping plate 12 includes a frame 121, and a propping protrusion 122 having a sloping surface. The frame 121 is firmly fitted into the positioning trench 114 with the propping protrusion 122 facing the holding room 113. The fixing hook 13 has an elongated portion (not numbered) connected to the plate 12, and an engaging part 131 positioned on the sloping propping protrusion 122 to the plate 12; thus, the engaging part 131 sticks out into the holding room 113.

The depressable member 15 includes a main body 151, a spring 152 connected to a lower part of the main body 151, conductive elements 153 connected to the main body 151, and a bottom 154 connected to the top of the main body 151. An engaging board 16 is secured to one side of the main body 151. The main body 151 is up and down movably passed into the holding room 113 with the engaging board 16 facing the fixing hook 13, and with the spring 152 being located on the upper side of the bottom part 111 to bias the same upwards. The engaging board 16 has an engaging surface 161, which is formed with a lower stopped block 162, an upper guiding block 163 above the lower block 162, and a guiding trench 164 surrounding both the lower and the upper blocks 162, 163. The guiding trench 164 includes a power-off area 166, which is below the lower stopped block 162, and a power-on spot 165, which is right above the upper part of the stopped block 162.

The spring 152 normally biases the main body 151 up to a power-off position where the conductive elements 153 are kept away from the upper portions of the conductive rods 14 and the engaging part 131 of the fixing hook 13 is received in the power-off area 166 of the guiding trench 164. When the user depresses the depressable member 15 from the button 154 so as to cause the conductive elements 153 to come into contact with the upper portions of the conductive rods 14, the engaging board 16 is moved relative to the fixing hook 13 so as to cause the engaging part 131 to move into between the lower stopped block 162 and the upper guiding block 163 due to the guiding trench 164; thus, the engaging part 131 of the hook 13 will be located on the power-on spot 165, and will engage the lower stopped block 162 to stop the main body 151 of the depressable member 15 from moving upwards when the user stops depressing the button 154. Therefore, the conductive elements 153 of the depressable member 15 are kept in contact with the conductive rods 14 for allowing the flow of electricity.

Similarly, to cut off the electricity, the button 154 is depressed for the engaging board 16 to move relative to the fixing hook 16 so as to cause the engaging part 131 to move out of the power-on spot 165 of the guiding trench 164; thus, the engaging part 131 will be received in the power-off area 166 when the user stops depressing the button 154, allowing the spring 152 to bias the depressable member 15 upwards to the power-off position.

However, the switch is found to have a drawback that in order for the engaging part 131 of the fixing hook 13 to abut the trench 164 of the engaging board 16, the switch needs an additional components, i.e. the propping plate 12 for connection to the fixing hook; consequently, the assembly would cost more labor and time.

### SUMMARY OF THE INVENTION

Therefore, it is a main object of the present invention to provide a switch having a member depressable for starting the flow of electricity, which has less complicated structure and can be assembled with less labor.

The switch of the present invention includes a base, several conductive rods, a fixed hook, and a depressable member.

The base has a first bottom part and an annular wall defining a holding room having an upper opening; the bottom part has insertion holes thereon.

The conductive rods are each passed through one of the insertion holes with a first contact being positioned in the holding room and with a lower part sticking out for connection to a socket.

The fixing hook is positioned in the holding room, and has a lower secured portion positioned adjacent to the first bottom part. The fixing hook further has an upper engaging portion and an interposed portion connected to both the engaging portion and the secured portion; the interposed portion is arranged close to the annular wall, and leans forwards, to as to position the engaging portion in the holding room.

The depressable member is up-and-down movably received in the holding room, and has second contacts each facing a respective one of the first contacts. The depressable member is biased up to a power-off position by a spring positioned between the secured portion and a lower part thereof, in the power-off position, the second contacts are kept away from the first contacts. The depresable member has an engaging surface facing the engaging portion of the hook for disengagably engaging the engaging portion so as to; thus, the same can be fixed in a power-on position when same is depressed from the power-off position, causing the second contacts to get into contact with the first contacts.

In addition, the base has a protruding portion sticking down from the first bottom part; the protruding portion has a slot on a bottom, and an upper and a lower securing blocks sticking out into the slot. The hook secured portion is positioned in the slot, and held in position by the upper and the lower securing blocks so as to be able to bend when the depressable member is depressed and causes the spring to press the secured portion; therefore, the leaning interposed portion of the hook can lean further forwards, and the engaging portion can move further into the holding room to abut the engaging surface.

Thus, the fixing hook doesn't need an additional propping element like that of the conventional switch.

### BRIEF DESCRIPTION OF THE DRAWINGS

The present invention will be better understood by reference to the accompanying drawings, wherein:

FIG. 1 is an exploded perspective view of the conventional switch in the Background.

FIG. 2 is an exploded sectional view of the conventional switch of FIG. 1.

FIG. 3 is sectional view of the switch of the present invention in the power-off position.

FIG. 4 is a top view of the base combined with the fixing hook of the switch according to the present invention.

FIG. 5 is a view of the engaging surface of the switch of the present invention, and the engaging portion of the hook in the power-off area.

FIG. 6 is a sectional view of the switch of the present invention in the power-on position.

FIG. 7 is a view of the engaging surface of the switch of the present invention, and the engaging portion in the power-on spot.

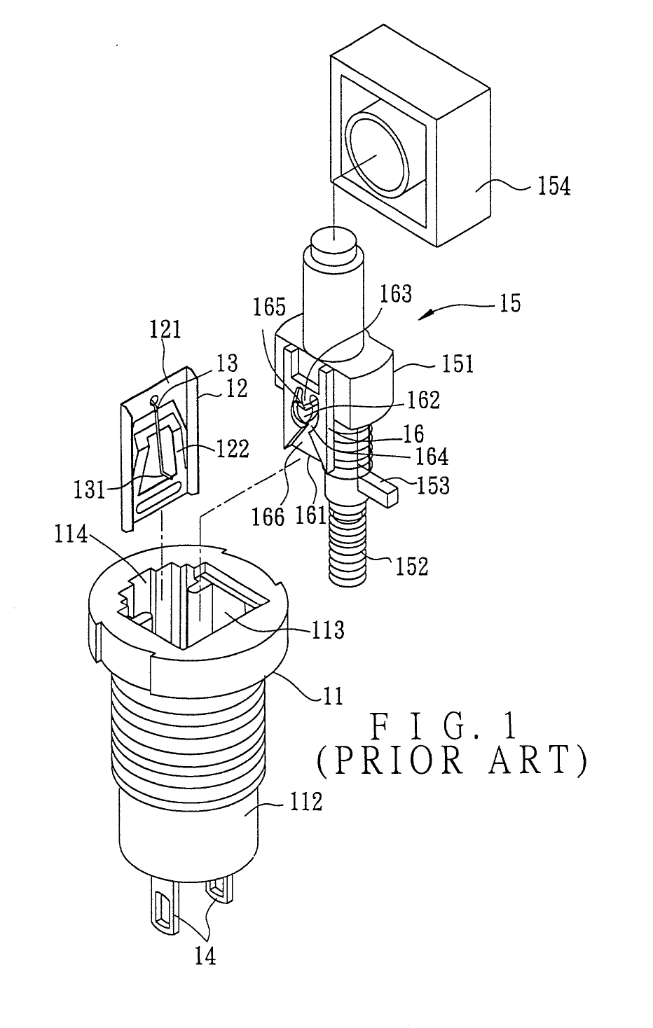

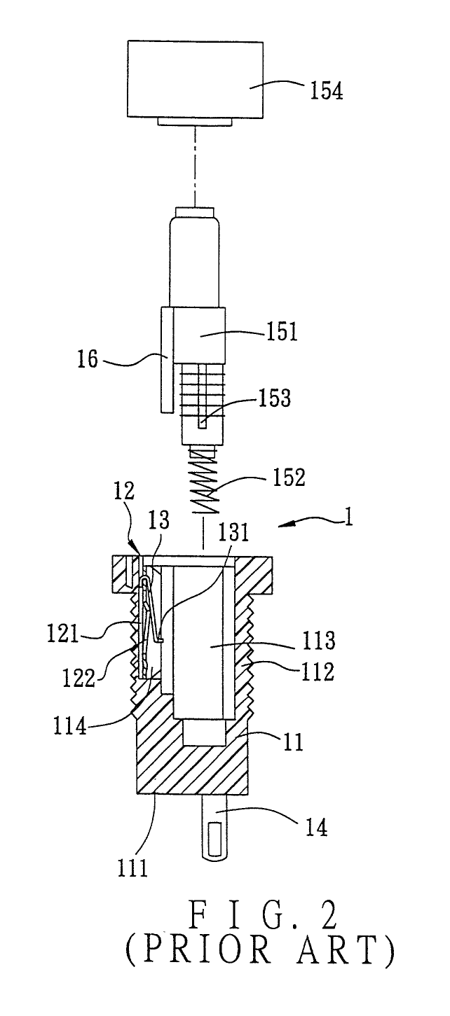

### DETAILED DESCRIPTION OF THE PREFERRED EMBODIMENT

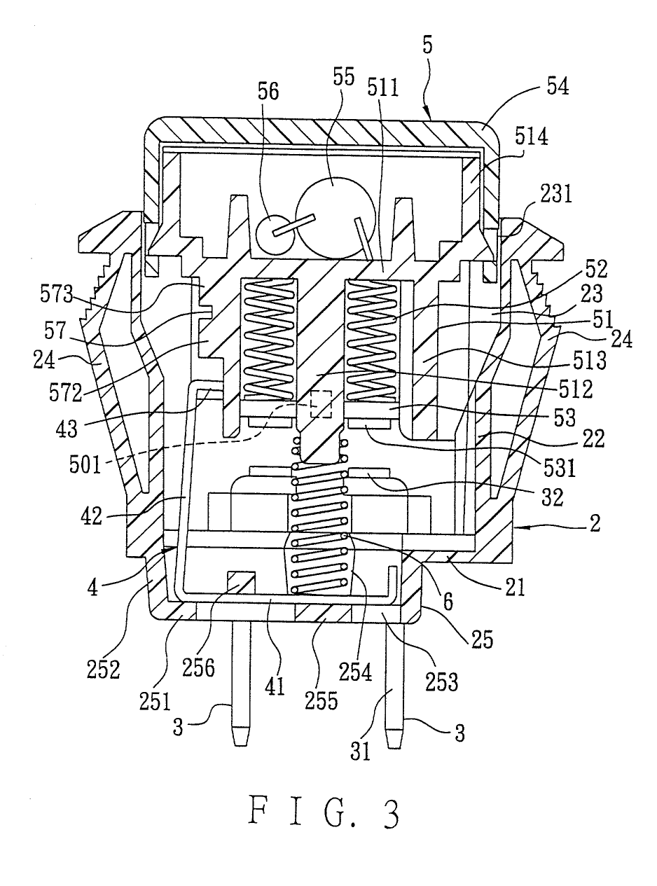

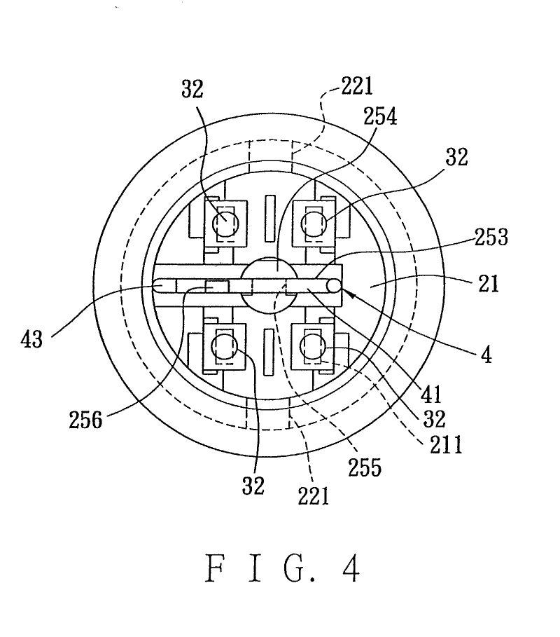

Referring to FIGS. 3 and 4, a switch having a depressable member of the present invention includes a base 2, four conductive rods 3, a fixing hook 4, the depressable member 5 and a first spring 6.

The base 2 has a first bottom part 21, an annular wall 22 perpendicular the bottom part 21; the annular wall 22 defines a holding room 23 having an upper opening 231, and is formed with two opposing connecting wings 24 on the outer side for connection thereof to other object. The annular wall 22 is further formed with two guide trenches 221 extending vertically from the top to the lower part of the inner side; the guide trenches 221 are preferably interposed between the wings 24.

A protruding portion 25 is formed on the lower side of the first bottom part 21 of the base 2; the protruding portion 25 includes a surrounding wall 252 connected to the first bottom part 21, and a second rectangular bottom part 251 connected to the lower end of the surrounding wall 252. The rectangular bottom part 251 has an elongated slot 253 lengthwise formed thereon; an upper securing block 256 is formed on the upper part of the rectangular bottom part 251, and sticks out into the elongated slot 253, while a lower securing block 255 is formed on the lower part of the rectangular bottom part 251, and sticks out into the slot 253. A pair of opposing locating recesses 254 are formed on the inner sides of the surrounding walls 252 right in the center of the first bottom part 21, and communicates with the slot 253 such that the lower part of the first spring 6 can be securely received between the opposing recesses 254. The first bottom part 21 is further formed with two pairs of parallel insertion holes 211; the distances from the center of the first bottom part 21 to the insertion holes 211 are the same; all the insertion holes 211 point to same direction.

The conductive rods 3 each has a lower part 31, and a first contact 32, and are each sassed through a respective one of the insertion holes 211 with the first contact 32 being received in the holding room 23, and the lower part 31 sticking out from the bottom part 21 for connection to a socket.

The fixing hook 4 includes a lower secured portion 41, an upper engaging portion 43, and a sloping portion 42 between the portions 41 and 43; the lower secured portion 41 is lengthwise positioned on the elongated slot 253, and is held in position by the securing blocks 255, 256, and one end of the rectangular bottom part 251; the sloping portion 42 is folded to slightly leans forward so as to allow the engaging portion 43 to be closer to the center of the holding room 23.

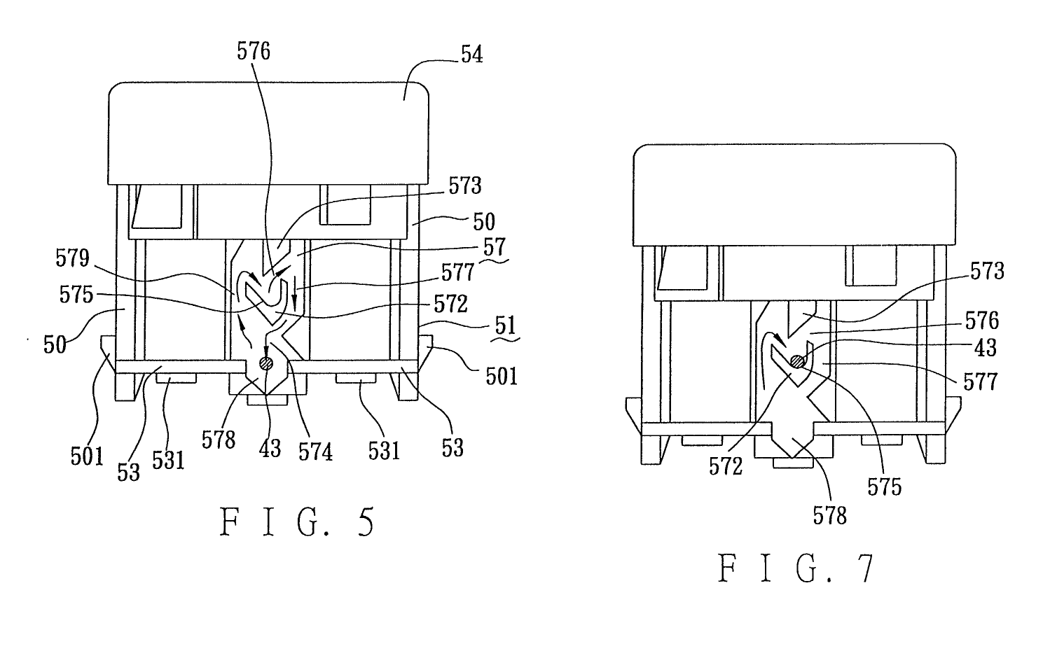

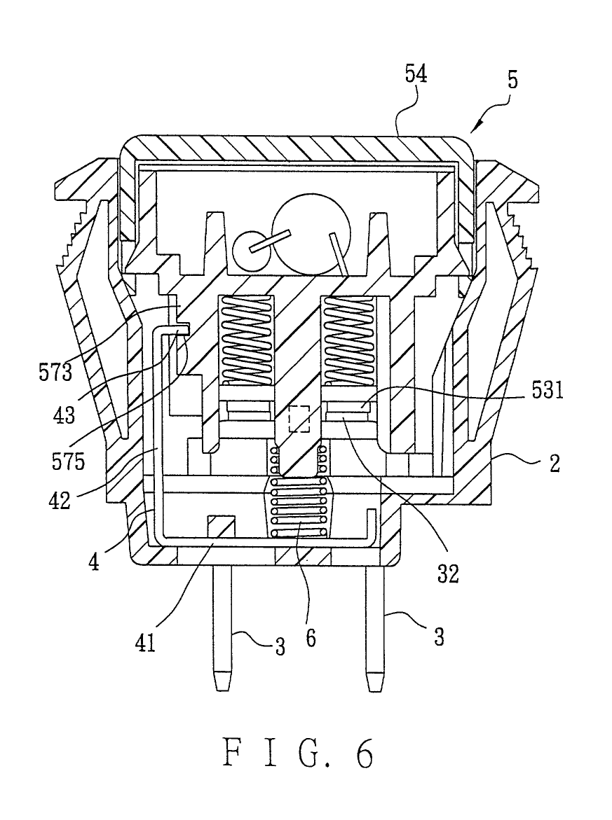

Referring to FIGS. 3 and 5, the depressable member 5 includes a main body 51, pushing springs 52, contact boards 53, and a bottom 54. The main body 51 has a middle horizontal portion 511, from which an annular protrusion 514 sticks upwards, and two opposing lateral walls 513 stick down. The main body 51 further has two board-shaped parts 50 sticking down from the horizontal portion 511 and between the lateral walls 513; the board-shaped parts 50 are each formed with a guided block on the lower part of the outer side there of. A locating protrusion 512 sticks down from the center of the horizontal portion 511.

The pushing springs 52 are positioned between the central locating protrusion 512 and the opposing walls 513. The contact boards 53 are each connected to the lower end of a respective one of the pushing springs 52; the contact boards 53 each further has a second contact 531 on the lower side. The button 54 is mounted on the annular protrusion 514 for connection to the main body 51. The depressable member 5 is up-and-down movably passed into the holding room 23 with the second contacts 531 each facing a respective one of the first contacts 31 of the conductive rods 3, and with the lower end of the central locating protrusion 512 being connected to the upper end of the first spring 6, and with the guided blocks 501 each being movably received in one of the guide trenches 221 of the base annular wall 22. Furthermore, a resistor 56, and an indicating lamp 55 are received between the button 54 and the horizontal portion 511, and electrically connected to the contact boards 53 for indicating whether the flow of electricity is started.

Referring specifically to FIG. 5, an engaging surface 57 is formed on a lateral side of the main body 51; the engaging surface 57 faces both the engaging portion 43 and the sloping portion 42 of the fixing hook 4, and has a lower stopped block 572, an upper guiding block 573 above the lower block 572, and a guiding trench 574 surround both the lower end the upper blocks 572 and 573. The guide trench 574 includes a power-off area 578, which is below the lower stopped block 572, and a power-on spot 575, which is right above the upper part of the lower stopped block 572; the guiding trench 574 can be further divided into a first guiding section 576 adjacent to the sloping edge of the upper guiding block 573, a second guiding section 577 adjacent to the right edge of stopped block 572, and a third guiding section 579 adjacent to the left edge of the stopped block 572.

The first spring 6 normally biases the depressable member 5 up to a power-off position where the second contacts 531 are kept away from the first contacts 31, and where the engaging portion 43 of the fixing hook 4 is received in the power-off area 578 of the guiding trench 574. When the user depresses the button 54 so as to cause the second contacts 531 to come into contact with the first contacts 32, the engaging surface 57 is moved down relative to the engaging portion 43 so as to cause the engaging portion 43 to move into between the lower stopped block 572 and the upper guiding block 573; thus, the engaging portion 43 will be located on the power-on spot 575 to engage the stopped block 572 to stop the main body 51 from moving upwards when the user stops depressing the button 54. Therefore, the second contacts 531 are kept S in contact with the first contacts 32 of the conductive rods 3 for allowing the flow of electricity. Above all, when the depressable member 5 is depressed, the first spring 6 under pressure will cause the secured portion 41 of the fixing hook 4 abutting the lower end of the same to bend such that the engaging portion 43 can be moved further into the holding room 23 to sufficiently get into contact with the engaging surface 57.

Similarly, to cut off the electricity, the button 54 is pressed down from the power-on position for the engaging surface 57 to move down relative to the engaging portion 43 so as to cause the engaging portion 43 to move along the first guiding section 576 of the trench 574 to separate from the power-on spot 575; thus, the engaging portion 43 will abut the power-off area 578 when the user stops depressing the button 54 to allow the first spring 6 to bias the member 5 upwards to the power-off position.

When the depressable member 5 is moved up and down, the guided trenches 221 of the base annular wall 22, in which the guided blocks 501 of the member 5 are received, will help the same move smoothly-without possibility of deviation.

From the above description, it can be seen that the fixing hook 4 is directly positioned in the base 2 without the use of an additional propping element; both the sloping portion 42 of the hook 4 and the downward movement of the depressable member 5 can help the engaging portion 43 to sufficiently abut the power-on spot 575 of the engaging surface 57. Thus, the switch of the present invention has fewer components and needs less labor in the assembly as compared with the conventional switch in the Background.

What is claimed is:

1. A switch, comprising
a base having a first bottom part, and an annular wall formed on said first bottom part; said annular wall defining a holding room having an upper opening; said bottom part having at least two insertion holes thereon;
conductive rods each being passed through one of said insertion holes with a first contact being received in said holding room and with a lower part sticking out for connection to a socket;
a fixing hook positioned in said holding room; said fixing hook having a lower secured portion positioned adjacent to said first bottom part of said base; said fixing hook having an upper engaging portion and an interposed portion connected to both said engaging portion and said lower secured portion; said interposed portion being arranged close to said annular wall and leaning forwards so as to position said engaging portion in said holding room;
a depressable member, said depressable member being up-and-down movably received in said holding room of said base; said depressable member having second contacts each facing a respective one of said first contacts of said conductive rods; said depressable member being biased up by a spring positioned between said secured portion of said fixing hook and same to a power-off position where said second contacts are kept away from said first contacts; said depressable member having an engaging surface on a lateral side for disengagably engaging said engaging portion of said fixing hook so as to be fixed in a power-on position when same is pressed down from said power-off position to cause said second contacts to get into contact with said first contacts.

2. The switch as claimed in claim 1, wherein said base has a rectangular protruding portion sticking down from said first bottom part; said lower secured portion of said fixing hook being lengthwise positioned on a second bottom part of said rectangular protruding portion.

3. The switch as claimed in claim 2, wherein said rectangular protruding portion has a surrounding wall connected to said first bottom part; said surrounding wall being formed with two opposing recesses for allowing a lower end of said spring to securely received therebetween.

4. The switch as claimed in claim 2, wherein said second bottom part has a slot lengthways formed thereon, and has an upper securing block and a lower securing block sticking out into said slot; said lower secured portion of said fixing hook being positioned in said slot, and below said upper block and above said lower block so as to be able to bend when said depressable member is depressed for starting flow of electricity thus causing said sprig to press said lower secured portion, and causing said leaning portion of said fixing hook to lean further forwards for said engaging portion to move towards a center of said holding room to abut said engaging surface.
